(19) United States
(12) Patent Application Publication
(10) Pub. No.: US 2024/0205742 A1
(43) Pub. Date: Jun. 20, 2024

(54) WIRELESS COMMUNICATION METHOD AND DEVICE

(71) Applicant: GUANGDONG OPPO MOBILE TELECOMMUNICATIONS CORP., LTD., Dongguan (CN)

(72) Inventors: Lei HUANG, Singapore (SG); Hongyan LI, Dongguan (CN); Huan HAN, Dongguan (CN); Shun ZHANG, Dongguan (CN); Chaoming LUO, Dongguan (CN); Liuming LU, Dongguan (CN)

(73) Assignee: GUANGDONG OPPO MOBILE TELECOMMUNICATIONS CORP., LTD., Dongguan (CN)

(21) Appl. No.: 18/591,768

(22) Filed: Feb. 29, 2024

Related U.S. Application Data
(63) Continuation of application No. PCT/CN2021/117771, filed on Sep. 10, 2021.

(51) Int. Cl. H04W 28/06

(52) U.S. Cl. CPC H04W 28/06

(57) ABSTRACT

A wireless communication method and device. The method comprises: a first device sending a first aggregate media access control protocol data unit (A-MPDU) to a second device, wherein the first A-MPDU comprises modulation and coding scheme feedback (MFB) information of at least one link.

### CROSS REFERENCE TO RELATED APPLICATIONS

The present application is a continuation application of the international patent application No. PCT/CN2021/117771, filed on Sep. 10, 2021, and contents of which are incorporated herein by its entireties.

### TECHNICAL FIELD

The present disclosure relates to the field of communication, and in particular to a wireless communication method and a wireless communication device.

### BACKGROUND

A physical layer of a wireless local area network supports the link adaptation (LA) technology. The LA technology enables parameters, such as modulation and coding scheme (MCS), to be adaptively adjusted according to channel conditions of the link.

The high efficiency link adaptation (HLA) mechanism in the art is not applicable to the cases that use a larger bandwidth and more spatial streams in the 802.11be. Specifically, in the 802.11ax, the maximum supported bandwidth is 160 MHz, the maximum number of spatial streams is 8, and one station (STA) can assign only one resource unit (RU). In the 802.11be, the maximum supported bandwidth is 320 MHz, the maximum number of spatial streams is 16, and one STA can assign one RU or a multiple resource unit (MRU). Therefore, how to support link adaptation in scenarios of larger bandwidth or more spatial streams is an urgent problem to be solved.

In some scenarios, a new multilink protocol and framework is defined to implement a multilink logical entity to meet higher performance requirements. How to achieve link adaptation in multilink scenarios is also an urgent problem to be solved.

### SUMMARY OF THE DISCLOSURE

In a first aspect, a wireless communication method is provided and includes: sending, by a first device, a first aggregate medium access control protocol data unit (A-MPDU) to a second device, wherein the first A-MPDU comprises modulation and coding scheme feedback (MFB) information of at least one link.

In a second aspect, a wireless communication device is provided and includes: a processor and a memory for storing computer programs, wherein the processor is configured to invoke and run the computer programs stored in the memory to perform the method of the first aspect.

In a third aspect, a chip is provided to perform the method of the first aspect or the second aspect.

Specifically, the chip includes: a processor configured to invoke and run computer programs from a memory to cause a device arranged with the chip to perform the method of the first aspect or the second aspect.

### BRIEF DESCRIPTION OF THE DRAWINGS

FIG. 1 is a schematic view of a communication system architecture according to an embodiment of the present disclosure.

FIG. 2 is a schematic view of a system architecture in which the embodiments of the present disclosure are applied.

FIG. 3 is a flow chart of a wireless communication method according to an embodiment of the present disclosure.

FIG. 4 is a schematic view of a format of an ELA control field according to an embodiment of the present disclosure.

FIG. 5 is a schematic interaction view of a single-link solicited MFB according to an embodiment of the present disclosure.

FIG. 6 is a schematic interaction view of a single-link unsolicited MFB according to an embodiment of the present disclosure.

FIG. 7 is a schematic interaction view of a multilink adaptation feedback according to an embodiment of the present disclosure.

FIG. 8 is a schematic view of a frame format of an action frame that carries the MFB request information according to an embodiment of the present disclosure.

FIG. 9 is a schematic view of a frame format of a BA frame that carries the multilink MFB information according to an embodiment of the present disclosure.

FIG. 10 is a schematic view of a format of a multilink MFB field according to an embodiment of the present disclosure.

FIG. 11 is a schematic view of a format of an MFB information field of a solicited link according to an embodiment of the present disclosure.

FIG. 12 is a schematic view of a format of an MFB information field of an unsolicited link according to an embodiment of the present disclosure.

FIG. 13 is a schematic view of a wireless communication device according to an embodiment of the present disclosure.

FIG. 14 is a schematic view of a wireless communication device according to an embodiment of the present disclosure.

FIG. 15 is a schematic view of a communication device according to an embodiment of the present disclosure.

FIG. 16 is a schematic view of a chip according to an embodiment of the present disclosure.

FIG. 17 is a schematic view of a communication system according to an embodiment of the present disclosure.

### DETAILED DESCRIPTION

Technical solutions in embodiments of the present disclosure will be described below by referring to the accompanying drawings in the embodiments of the present disclosure. Apparently, the described embodiments are a part of, not all of, the embodiments of the present disclosure. All other embodiments, which are obtained by any ordinary skilled person in the art based on the embodiments in the present disclosure without making creative work, shall fall within the scope of the present disclosure.

Technical solutions of the embodiments of the present disclosure may be applied to various communication systems, such as Wireless Local Area Networks (WLAN), Wireless Fidelity (WiFi), or other communication systems.

Exemplarily, a communication system 100 applied in the embodiments of the present disclosure is shown in FIG. 1. The communication system 100 may include an access point (AP) 110, and a station (STA) 120 that accesses a network through the AP 110.

In some scenarios, the AP may be referred to as an AP STA. That is, in these cases, the AP is also the STA. In some cases, the STA may be referred to as a non-AP STA.

In some embodiments, the STA may include an AP STA and a non-AP STA.

Communication in the communication system 100 may be between the AP and the non-AP STA, or between one non-AP STA and another non-AP STA, or between the STA and a peer STA. The peer STA may refer to a device that communicates with the STA in an end-to-end manner. For example, the peer STA may be an AP or a non-AP STA.

The AP is equivalent to a bridge connecting a wired network with a wireless network. A main function of the AP is to connect various clients of the wireless network together and allows the wireless network to access the Ethernet. The AP device may be a terminal device (such as a mobile phone) or a network device (such as a router) having a chip with wireless-fidelity (WiFi).

It should be understood that the role of the STA in the communication system is not fixed. For example, in some scenarios where a mobile phone is connected to a route, the mobile phone is the non-AP STA. In some cases, the mobile phone serves as a hotspot for other mobile phones, and the mobile phone serves as the AP.

The AP and the non-AP STA may be devices applied in the Internet of Vehicles, IoT nodes and sensors in the IoT, smart cameras in smart homes, smart remote controls in smart homes, smart water meters and electrometers in smart homes, and sensors in smart cities.

In some embodiments, the non-AP STA may support 802.11be. The non-AP STA may also be a device that supports 802.11ax, 802.11ac, 802.11n, 802.11g, 802.11b, 802.11a, and 802.11a, and many other current and future 802.11 families of the wireless local area network (WLAN).

In the present embodiment, the STA may be devices that support the WLAN/WiFi and may include a mobile phone, a pad computer, a personal computer, a virtual reality device, an augmented reality device, a wireless device in industrial control, a set-top box, a wireless device for self-driving, a vehicle-mounted communication device, a wireless device in remote medical care, a wireless device in smart grid, a wireless device in transport safety, a wireless device in the smart city or the smart home, a wireless communication chip/ASIC/SOC, and so on.

Frequency bands that can be supported by the WLAN technology include but are not limited to: low-frequency bands (2.4GHz, 5GHz, 6GHz) and a high-frequency band (60GHz).

FIG. 1 shows one AP STA and two non-AP STAs as an example. In some embodiments, the communication system 100 may include a plurality of AP STAs and other numbers of non-AP STAs. The number of the AP STAs and the number of the non-AP STAs are not limited herein.

It should be understood that any device having the communication function in the network/system in the embodiments of the present disclosure is referred to as the communication device. Taking the communication system 100 illustrated in FIG. 1 as an example, the communication device includes an access point 110 and a station 120 having the communication functions. The access point 110 and the station 120 may be the devices as described in the above and will not be repeated herein. The communication device may further include other devices in the communication system 100, such as a network controller, a gateway, and other network entities, which will not be limited herein.

It should be understood that the terms “system” and “network” are often used interchangeably herein. The term “and/or” herein is merely a description of an association relationship of the mentioned objects, indicating that three kinds of relationships can exist. For example, A and/or B means that: A is present alone, A and B are present at the same time, and B is present alone. In addition, the character “/” herein generally indicates that an object or another obj ect.

It should be understood that the term “instructs” in the embodiments of the present disclosure may be a direct instruction, an indirect instruction, or may suggest that two objects are associated with each other. For example, A instructing B means that: A instructs B directly, such as B obtaining instructions through A; or A instructs B indirectly, such as A instructing C, and B obtaining instructions through C; or A is associated with B.

In the specification, the term “corresponding” indicates that two objects directly or indirectly correspond to each other; or indicates that two objects are associated with each other; or indicates that one object instructs another object or one object performs configuration for another obj ect.

In the embodiments of the present disclosure, “predetermination” may be achieved by storing corresponding codes or tables in advance in a device (such as in the access point and the station), or by performing other means to indicate relevant information. The present disclosure does not limit specific implementations thereof. For example, predetermination may refer to definition in a protocol.

Wireless devices support multi-band communication, such as simultaneous communication in frequency bands of 2.4 GHz, 5 GHz, 6 GHz, and 60 GHz, or simultaneous communication on different channels in a same frequency band (or different frequency bands), such that throughput and/or reliability of communication between devices is improved. Such devices are commonly referred to as multi-band devices or multi-link devices (MLDs) or multi-link entities or multi-band entities. The multi-link device can be an access point device or a station device. When the multi-link device is the access point device, the multi-link device includes one or more APs. When the multi-link device is the station device, the multi-link device includes one or more non-AP STAs.

The multi-link device, which includes one or more APs, may be named as the AP MLD. The multi-link device, which includes one or more non-AP STAs, may be named as the non-AP MLD. In the present disclosure, the non-AP MLD may be referred to as an STA MLD.

In the present disclosure, the AP MLD includes a plurality of APs, the non-AP MLD includes a plurality of STAs. A plurality of links are established between the plurality of APs in the AP MLD and the plurality of STAs in the non-AP MLD, where each of the plurality of links is established between one of the plurality of APs and a corresponding one of the plurality of STAs. Data communication may be achieved between the APs in the AP MLD and the corresponding STAs in the Non-AP MLD via the corresponding links.

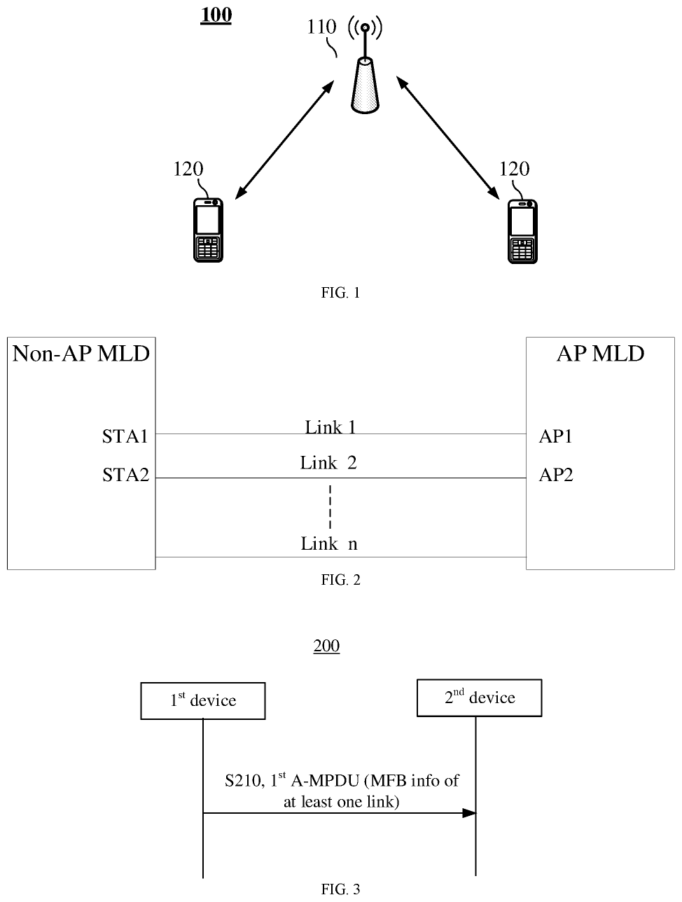

As shown in FIG. 2, the AP MLD includes an AP1, an AP2, and so on. The non-AP MLD includes a STA1, a STA2, and so on. A link 1 is established between the AP1 and the STA1; a link 2 is established between the AP2 and the STA2p; and so on. Data communication are achieved between the AP1 and the STA1 via the link 1, and data communication are achieved between the AP2 and the STA2 via the link 2.

In the 802.11ax, a maximum bandwidth that can be supported is 160 MHz, a maximum number of spatial streams is 8, and only one RU can be assigned to one STA.

In the 802.11be, a maximum bandwidth that can be supported is 320 MHz, a maximum number of spatial streams is 16, and one STA can be assigned with one RU or one MRU.

Therefore, how to achieve link adaptation in a situation of a larger bandwidth and more spatial streams is an urgent problem to be solved.

In the 802.11ax, an HLA control subfield is used for link adaptation. A bandwidth (BW) field in the HLA control subfield is 2 bits, an RU allocation field is 8 bits, and a field of the number of spatial streams (NSS) is 3 bits. The HLA control field can only have 26 bits at most, which is not enough to support the maximum bandwidth and the maximum number of spatial streams of the 802.11be.

Therefore, how to achieve link adaptation in scenarios of multi-links is also an urgent problem to be solved.

In order to facilitate understanding of technical solutions of the embodiments of the present disclosure, the technical solutions of the present disclosure are described in detail below by referring to specific embodiments. The above related technologies serve as optional solutions and can be arbitrarily combined with the technical solutions of the embodiments of the present disclosure. All of the combined technical solutions shall fall within the scope of the present disclosure. The embodiments of the present disclosure include at least some of the following.

FIG. 3 is a flow chart of a wireless communication method 200 according to an embodiment of the present disclosure. The wireless communication method 200 includes at least some of the following contents.

In an operation S210, a first device sends a first aggregate medium access control protocol data unit (A-MPDU) to a second device. The first A-MPDU includes modulation and coding scheme feedback (MFB) information of at least one link.

The MFB information in the present disclosure may be referred to as link adaptation information.

It should be understood that the MFB information of the at least one link may be carried in any data unit sent by the first device to the second device. The present disclosure is illustrated by taking the A-MPDU carrying the MFB information of the link as an example, but the present disclosure is not limited thereto.

In some embodiments, the first device is a station device, and the second device is another station device. Each station device may be a non-AP STA or an AP STA.

In an example, the first device is a non-AP STA, and the second device is an AP STA.

In another example, the first device is an AP STA, and the second device is a non-AP STA.

In yet another example, each of the first device and the second device is a non-AP STA.

Therefore, in embodiments of the present disclosure, the first device sends the link adaptation information of the at least one link to the second device, so that the second device can quickly adjust link parameters based on the link adaptation information to improve reliability of data transmission.

From the perspective of sending and receiving the MFB information, the first device may be referred to as an MFB sending end, and the second device may be referred to as an MFB receiving end.

From the perspective of requesting and feeding back the MFB information, the first device may be referred to as an MFB feedback end, and the second device may be referred to as an MFB request end.

In some embodiments, the MFB information of the at least one link may include at least one of the following:

MCS, NSS, BW, RU allocation information, partial physical layer protocol data unit (PPDU) parameters, and transmission beam-forming (Tx Beam-forming).

In some embodiments, the first device may proactively feed back the MFB information of the at least one link to the second device. In other words, the first device feeds back, without receiving any request, the MFB information of the at least one link to the second device. This type of feedback may be referred to as unsolicited MFB or MFB without request.

In some embodiments, the first device may feed back, based on a request from the second device, the MFB information of the at least one link to the second device. This type of feedback may be referred to as solicited MFB or request-based MFB.

It should be understood that embodiments of the present disclosure may be applicable to single-link adaptation feedback or multi-link adaptation feedback, such as in an MLD scenario of feeding back the MFB information of one or more links.

Hereinafter, specific implementations of single-link adaptation feedback and multi-link adaptation feedback will be described by referring to Embodiment I and Embodiment II.

### Embodiment I: Single-Link Adaptation Feedback

In the Embodiment I, the unsolicited MFB may be referred to as single-link unsolicited MFB, and the solicited MFB may be referred to as single-link solicited MFB.

In the Embodiment I, the first A-MPDU includes MFB information of the single link.

In the Embodiment I, the first A-MPDU includes a first frame. The single-link MFB information is carried in the first frame. For example, the single-link MFB information may be carried in a header of the first frame.

In some embodiments, the first frame is a data frame or a management frame, or may be other frames, which is not limited herein. In some embodiments, the data frame may be an Null frame.

In some embodiments, the number of first frames is one or more. For example, the first device may carry the MFB information of the single link via at least one data frame and/or at least one management frame.

In some embodiments, the first A-MPDU further includes a block acknowledgement (BA) frame. The first frame is located after the BA frame in the first A-MPDU.

In some embodiments, the first frame further includes indication information of a feedback type, configured to indicate a feedback type of the single-link MFB information, such as the unsolicited MFB or the solicited MFB.

In some embodiments, the first frame includes a first extremely high throughput (EHT) link adaptation control field (ELA control field). The first ELA control field is configured to carry the single-link MFB information. For example, the first ELA control field may include a corresponding field for carrying the single-link MFB information, such as an MCS field, an NSS field, and so on.

In some implementations, the first ELA control field includes an unsolicited (or proactive, autonomous) MFB field and a first indication field. The first indication field is an MCS request (MRQ) field or an Uplink Extremely High Throughput Trigger-Based Physical layer Protocol Data Unit Modulation and coding scheme FeedBack (UL EHT TB PPDU MFB) field. That is, the first indication field may be interpreted as the MRQ field or the UL EHT TB PPDU MFB field.

Further, different values of other fields in the first ELA control field indicates whether the first indication field is the MRQ field or the UL EHT TB PPDU MFB field.

In some embodiments, the first indication field may be referred to the MRQ/UL EHT TB PPDU MFB field.

In some embodiments, the unsolicited MFB field is configured to indicate the feedback type of the MFB information, such as the unsolicited MFB or the solicited MFB. In a case where the unsolicited MFB field indicates that the feedback type of the MFB information is the unsolicited MFB, the first indication field is the UL EHT TB PPDU MFB field. In a case where the unsolicited MFB field indicates that the feedback type of the MFB information is the solicited MFB, the first indication field is the MRQ field.

That is, in the case where the unsolicited MFB field indicates that the feedback type of the MFB information is the unsolicited MFB, the MRQ/UL EHT TB PPDU MFB field is interpreted as the UL EHT TB PPDU MFB field; and in the case where the unsolicited MFB field indicates that the feedback type of the MFB information is the solicited MFB, the MRQ/UL EHT TB PPDU MFB field is interpreted as the MRQ field.

For the solicited MFB, in some embodiments, the method 200 further includes following operations.

The first device receives a second A-MPDU sent by the second device. The second A-MPDU is configured to request the first device to feed back the single-link MFB information.

In some embodiments, the second A-MPDU includes a second frame. The second frame includes MFB request information. The MFB request information is configured to instruct the second device to request the first device to feed back the single-link MFB information.

In some embodiments, the MFB request information is carried in the header of the second frame.

In some embodiments, the second frame is a data frame, a management frame, or other frames, which will not be limited herein. In some embodiments, the data frame may be an Null frame.

In some embodiments, the number of second frames is one or more. For example, the second device may carry the MFB request information via at least one data frame and/or at least one management frame.

In some embodiments, the second frame includes a second ELA control field. The second ELA control field is configured to carry the MFB request information. That is, the ELA control field in the second frame may be interpreted as an MFB request, a feedback request, or an ELA feedback request.

In some embodiments, one MFB request corresponds to one sequence number, such as an MCS request sequence identifier (MSI), such as taking values from 0 to 6, or the like.

Correspondingly, a feedback in response to the MFB request is an MFB response, a feedback response, or an ELA feedback response. The MFB response may also carry the MSI, indicating that the MFB response is the feedback in response to the MSI request.

In some embodiments, the second ELA control field includes the unsolicited MFB field and the first indication field. The first indication field is the MRQ field or the UL EHT TB PPDU MFB field. The second device use the unsolicited MFB field and the first indication field to cooperatively indicate the MFB request information, i.e., the first indication field may be interpreted as the MRQ field or the UL EHT TB PPDU MFB field.

In some embodiments, the ELA control field (such as the first ELA control field and the second ELA control field) are included in an HE variant HT control field. The ELA control field includes a 4-bit control ID field and a 26-bit control information field.

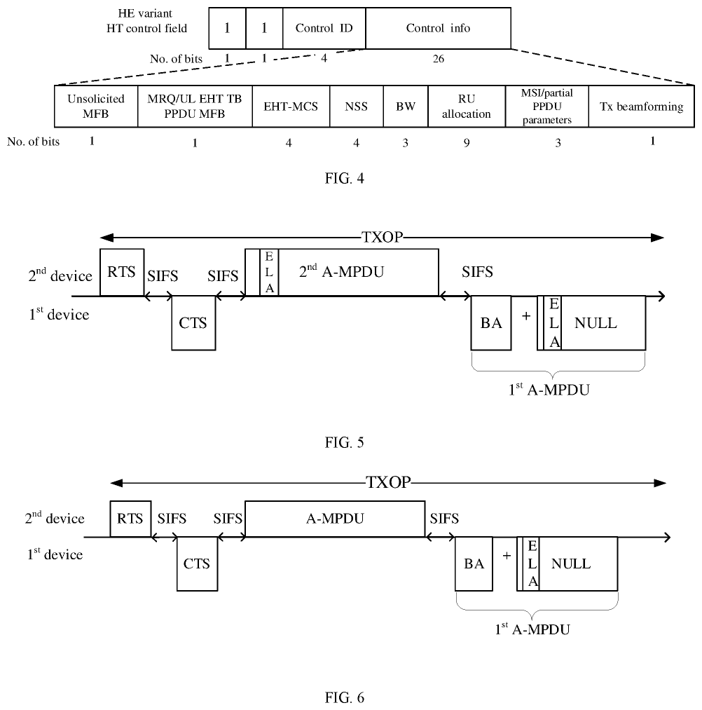

FIG. 4 is a schematic view of a format of the ELA control field that includes the ELA control field according to an embodiment of the present disclosure.

It should be understood that correspondence between meanings and the values of each of the following fields is only exemplary, as long as each meaning corresponds to one unique value, and the present disclosure is not limited thereto.

As shown in FIG. 4, the ELA control field may include at least one of the following fields:

1. The unsolicited MFB field is configured to indicate the feedback type (or a feedback mode) of the MFB information. The feedback type of the MFB information may alternatively be considered as a feedback type of the device, i.e., a manner that the device performs to feed back the MFB information.

In some embodiments, the unsolicited MFB field is 1 bit.

In an example I, the unsolicited MFB is set to 1 to indicate the unsolicited MFB, and is set to 0 to indicate the solicited MFB.

In an example II, the unsolicited MFB is set to 0 to indicate the unsolicited MFB, and is set to 1 to indicate the solicited MFB.

The following illustration is based on the indicative manner of the Example I, but the present disclosure is not limited thereto.

2. The MRQ/UL EHT TB PPDU MFB field is interpreted as the MRQ field or the UL EHT TB PPDU MFB field.

In some embodiments, the MRQ/UL EHT TB PPDU MFB field is 1 bit.

For example, when the unsolicited MFB field is set to indicate the unsolicited MFB, the MRQ/UL EHT TB PPDU MFB field is interpreted as the UL EHT TB PPDU MFB field.

Further, the UL EHT TB PPDU MFB field is set to have the value of 1 to indicate that the NSS field, the MCS field, the BW field, and the RU allocation field in the ELA control field is recommended MFB information for the PPDUs that will be sent by the first device. The UL EHT TB PPDU MFB field is set to have the value of 0 to indicate that the NSS field, the MCS field, the BW field, and the RU allocation field is recommended MFB information for the PPDUs that will be sent to the first device.

As another example, when the unsolicited MFB field indicates the solicited MFB, the MRQ/UL EHT TB PPDU MFB field is interpreted as the MRQ field.

In an example I, the MRQ field takes the value of 0 to indicate the feedback response, and the MRQ field takes the value of 1 to indicate the feedback request.

In an example II, the MRQ field takes the value of 1 to indicate the feedback response, and the MRQ field takes the value of 0 to indicate the feedback request.

The following is an illustration of the indicative manner of example one, but the present application is not limited thereto.

In some embodiments, the PPDU sent by the first device includes an EHT trigger-based (TB) PPDU.

In some embodiments, the PPDU sent to the first device includes a non-TB PPDU, such as an EHT multiple-user (MU) PPDU.

3. The EHT-MCS field is configured to indicate a recommended EHT-MCS.

In some embodiments, the EHT-MCS field is 4 bits.

In some embodiments, when the unsolicited MFB field is set to 1 and the MRQ/UL EHT TB PPDU MFB field is set to 0, or when the unsolicited MFB field is set to 0 and the MRQ/UL EHT TB PPDU MFB field is set to 0, the EHT-MCS field indicates the MCS recommended for the PPDUs that will be sent to the first device. For example, the EHT-MCS field may be set to be an EHT-MCS index.

In some embodiments, the EHT-MCS field indicates the MCS recommended for the PPDUs that will be sent from the first device when the unsolicited MFB field is set to 1 and the MRQ/UL EHT TB PPDU MFB field is set to 1. For example, the EHT-MCS field is set to be an EHT-MCS index.

The EHT-MCS field is reserved when the unsolicited MFB field and the MRQ/UL EHT TB PPDU MFB field are set to other values.

4. The NSS field is configured to indicate the number of recommended spatial streams.

The maximum number of spatial streams supported in the 802.11be is 16. Therefore, the NSS field may be designed to be 4 bits to meet demands of more spatial streams in the 802.11be.

In some embodiments, when the unsolicited MFB field is set to 1 and the MRQ/UL EHT TB PPDU MFB field is set to 0, or when the unsolicited MFB field is set to 0 and the MRQ/UL EHT TB PPDU MFB field is set to 0, the NSS field indicates the number of spatial streams recommended for the PPDUs that will be sent to the first device. For example, the NSS field is set to be N_{SS}-1.

In some embodiments, when the unsolicited MFB field is set to 1 and the MRQ/UL EHT TB PPDU MFB field is set to 1, the NSS field indicates the number of spatial streams recommended for the PPDUs that will be sent by the first device. For example, the NSS field is set to be N_{SS}-1.

The NSS field is reserved when the unsolicited MFB field and the MRQ/UL EHT TB PPDU MFB field are set to other values.

5. A BW field is configured to indicate a bandwidth to which the recommended EHT-MCS applies or a bandwidth requested by the MFB requesting end.

For example, in the first ELA control field, the BW field may be configured to indicate the bandwidth to which the recommended EHT-MCS applies.

In another example, in the second ELA control field, the BW field may be configured to indicate the bandwidth requested by the second device.

The maximum bandwidth supported in the 802.11be is 320 MHz. Therefore, the BW field may be designed to be 3 bits to meet requirements of the 802.11be for a larger bandwidth.

In some embodiments, when the unsolicited MFB field is set to 1 and the MRQ/UL EHT TB PPDU MFB field is set to 0, the BW field indicates a recommended bandwidth applicable to the PPDUs, that will use the recommended EHT-MCS, and be sent to the first device.

In some embodiments, when the unsolicited MFB field is set to 1 and the MRQ/UL EHT TB PPDU MFB field is set to 1, the BW field indicates a recommended bandwidth applicable to the PPDUs, that will use the recommended EHT-MCS, and be sent from the first device.

In some embodiments, when the unsolicited MFB field is set to 0 and the MRQ/UL EHT TB PPDU MFB field is set to 1, the BW field is interpreted as the bandwidth requested by the MFB requesting end.

That is, in the second ELA control field, the unsolicited MFB field is set to 0, the MRQ/UL EHT TB PPDU MFB field is set to 1, and the BW field is set to be the bandwidth requested by the second device.

6. The RU allocation field: configured to indicate the RU or MRU to which a recommend EHT-MCS applies, or the RU or the MRU requested by the MFB requesting end.

For example, in the first ELA control field, the RU allocation field is configured to indicate the RU or MRU to which the recommended EHT-MCS applies.

In another example, in the second ELA control field, the RU allocation field is configured to indicate the RU or MRU requested by the second device.

In the 802.11be, one terminal device may be assigned with one RU or one MRU. Therefore, the RU allocation field may be designed to be 9 bits.

In some embodiments, the specific RU or MRU may be indicated by the RU allocation field and the BW field cooperatively.

In some embodiments, when the unsolicited MFB field is set to 1 and the MRQ/UL EHT TB PPDU MFB field is set to 0, the RU allocation field indicates the RU or MRU applicable to the PPDUs, that will use the recommended EHT-MCS, and be sent to the first device.

In some embodiments, when the unsolicited MFB field is set to 1 and the MRQ/UL EHT TB PPDU MFB field is set to 1, the RU allocation field indicates the RU or MRU applicable to the PPDUs, that will use the recommended EHT-MCS, and be sent from the first device.

In some embodiments, when the unsolicited MFB field is set to 0 and the MRQ/UL EHT TB PPDU MFB field is set to 1, the RU allocation field is configured to indicate the RU or MRU requested by the second device.

The RU allocation field is reserved when the unsolicited MFB field and the MRQ/UL EHT TB PPDU MFB field are set to be other values.

7. MSI/Partial PPDU Parameters field.

In some embodiments, the MSI/Partial PPDU Parameters field is 3 bits.

In some embodiments, when the unsolicited MFB field is set to 0 and the MRQ/UL EHT TB PPDU MFB field is set to 1, the MSI /Partial PPDU Parameters field represents the sequence number of the MFB feedback request.

In some embodiments, when the unsolicited MFB field is set to 0 and the MRQ/UL EHT TB PPDU MFB field is set to 0, the MSI /Partial PPDU Parameters field represents a sequence number of the MFB feedback response. A value of the sequence number of the MFB feedback response is the same as a value of the sequence number of the corresponding feedback request.

In some embodiments, when the unsolicited MFB field is set to 1, the MSI /Partial PPDU Parameters field represents partial PPDU parameters including a format of the PPDU upon which the unsolicited MFB is measured, a coding type of PPDU upon which the unsolicited MFB is measured, and so on.

8. A Tx Beamforming field is configured to indicate whether the PPDU is beamformed.

In some embodiments, the Tx Beamforming field is 1 bit.

In some embodiments, when the unsolicited MFB field is set to 1 and the MRQ/UL EHT TB PPDU MFB field is set to 0, the Tx Beamforming field is configured to indicate whether the PPDU upon which the unsolicited MFB is measured is beamformed. The Tx Beamforming field set to 0 indicates the PPDU is not beamformed, and the Tx Beamforming field set to 1 indicates the PPDU is beamformed. Alternatively, the Tx Beamforming field set to 1 indicates the PPDU is not beamformed, and the Tx Beamforming field set to 0 indicates the PPDU is beamformed.

The Tx Beamforming field is reserved when the unsolicited MFB field and the MRQ/UL EHT TB PPDU MFB field are set to be other values.

As can be seen from the format of the ELA control field shown in FIG. 4, the format satisfies the demands of the ELA mechanism in the 802.11be for the larger bandwidth and more spatial streams.

FIG. 5 is a schematic interaction view of the single-link solicited MFB according to an embodiment of the present disclosure.

Firstly, the second device sends the second A-MPDU to the first device. The second A-MPDU includes the second frame, the second frame includes the ELA control field. The ELA control field includes MFB request information to indicate requesting a counterpart end to provide feedback of MFB information of a current link.

Specifically, the MRQ/UL EHT TB PPDU MFB field in the ELA control field is set to 1 and the unsolicited MFB field is set to 0 to indicate requesting the MFB information. In each feedback request, the MSI/Partial PPDU Parameters field is set to be an appropriate value, such as 0 to 6 to indicate the sequence number of the feedback request.

The MFB requesting end may use the RU allocation field and the BW field to cooperatively indicate the RU or MRU for which the MFB requester solicits feedback.

After receiving the second A-MPDU, the first device determines, based on the value of the unsolicited MFB field in the second A-MPDU, that it is the solicited MFB. Further, the first device sets the MRQ/UL EHT TB PPDU MFB field in the ELA control field of the first frame to 0 and sets the unsolicited MFB field to 0 to indicate one feedback response. Further, the first device sets other fields in the ELA control field, such as the EHT-MCS field and the NSS field, to carry the MFB information for the current link.

The value of the MSI/Partial PPDU Parameters field in the ELA control field in the first frame is the same as the value of the MSI/Partial PPDU Parameters field in the second frame, and the value indicates that the first device feeds the MFB information back to the second device.

In some embodiments, when the EHT-MCS field takes the value of 15 and the NSS field takes the value of 7, it is indicated that the first device does not feed the MFB information back to the second device.

Specifically, the first device may send the first A-MPDU at a time point that is a certain time interval, such as a short interframe space (SIFS), after the second A-MPDU is sent. The first A-MPDU includes the BA frame and the first frame. The first frame is after the BA frame.

FIG. 6 is a schematic interaction view of a single-link unsolicited MFB according to an embodiment of the present disclosure.

Specifically, when the first device is performing a BA frame response, the first device sends the first A-MPDU, in which the first frame is included and put after the BA frame, to the second device. The first frame includes the ELA control field. Specifically, the unsolicited MFB field in the ELA control field is set to 1 to indicate the unsolicited MFB. In this case, the second device may estimate the EHT-MCS, NSS, RU/MRU, and BW based on the received PPDU of which the format, the coding type, and the Tx beamforming matters.

In summary, in the present disclosure, the format of the ELA control field is designed to achieve requests and feedback of link adaptation in the EHT wireless local area network.

### Embodiment II: Multi-Link Adaptation Feedback

It should be understood that link adaptation feedback methods in the present embodiment may be applicable to feeding back the MFB information for a single link or feeding back the MFB information for a plurality of links.

For example, the Embodiment II may be applicable to link adaptation feedback in the scenario of multi-links or in the scenario of the single link.

It should be understood that, in the scenario of multi-links, the MFB feedback end may feed back the MFB information of a single link or feed back MFB information of multiple links, which is not limited herein.

In some scenarios, when the MFB information of each link is fed back independently, each link needs to adjust its parameters based on the fed back MFB information, after the MFB feedback request and response exchange. When the quality of a link is poor, latency of signaling exchange may be extended, and the received feedback information may be outdated, resulting in the link adaption being untimely. By performing the multi-link adaptation feedback method of the present embodiment, the first device, when obtaining adaptation information of multiple links, may feed back the adaptation information of the multiple links to the second device. In this way, rapid link adaption can be achieved, and reliability of the feedback information is improved.

In some embodiments, the first device is an AP MLD and the second device is a non-AP MLD.

In some embodiments, the first device is a non-AP MLD and the second device is an AP MLD.

In some embodiments, each of the first device and the second device is a non-AP MLD.

In the Embodiment II, the feedback type of the multi-link adaptation feedback may be the unsolicited MFB or the solicited MFB.

In the Embodiment II, the unsolicited MFB may referred to as a multi-link unsolicited MFB, the solicited MFB may be referred to as a multi-link solicited MFB, and the MFB request may be referred to as a multi-link MFB request.

For the solicited MFB, in some embodiments, the method 200 further includes following operations.

The first device receives a third A-MPDU sent by the second device. The third A-MPDU includes a third frame, the third frame is configured to request the first device to feed back MFB information of target link(s).

In some embodiments, the third frame includes link indication information configured to indicate the target link(s) of the MFB information that is requested to be fed back.

In some embodiments, the second device indicates, by means of a bitmap, the target link(s) of the MFB information that is requested to be fed back.

For example, the third frame includes a first bitmap. The first bitmap includes at least one bit, each bit corresponds to one link, and each bit takes a value to indicate whether to request feeding back MFB information of the corresponding link, or whether the corresponding link has a request for feedback.

In an example I, the bit taking the value of 1 indicates requesting the MFB information of the corresponding link to be fed back; and the bit taking the value of 0 indicates not requesting the MFB information of the corresponding link to be fed back. In an example II, the bit taking the value of 0 indicates requesting the MFB information of the corresponding link to be fed back; and the bit taking the value of 1 indicates not requesting the MFB information of the corresponding link to be fed back.

The following is illustrated based on the example I, but the present disclosure is not limited thereto.

In some embodiments, the number of bits of the first bitmap may be determined based on the maximum number of links between the first device and the second device. For example, when n links are established between the first device and the second device, the first bit map includes n bits corresponding to the n links. When the first bit takes the value of 1, it indicates that the MFB information of the link 1 is requested to be fed back. When the second bit takes the value of 0, it indicates that the MFB information of the link 2 is not requested to be fed back. Following bits are similar to the above.

In some embodiments, the third frame further includes resource indication information, configured to indicate a resource that is requested by the second device to feed back the MFB information.

In some embodiments, the resource indication information is configured to indicate at least one of the following:

BW information, configured to feed back the MFB information of the link;

RU allocation information, configured to feed back the MFB information of the link, such as the RU or the MRU.

In some embodiments, the MFB information of all links correspond to a same resource, or the MFB information of each link corresponds to an independent resource. That is, each link corresponds to independent resource indication information, or all links correspond to the same resource indication information.

In some embodiments, the second device may request a same bandwidth or different bandwidths for all links.

In some embodiments, the second device may request a same RU/MRU or different RUs/MRUs for all links.

In some embodiments, the first A-MPDU includes a fourth frame, the fourth frame includes MFB information of at least one link.

In some embodiments, the fourth frame further includes a first indication information.

The first indication information is configured to indicate whether the fourth frame includes the MFB information of the link(s).

In some embodiments, the fourth frame further includes link indication information. The link indication information is configured to indicate the target link(s) of which the first device feeds back MFB information .

In some embodiments, the first device indicates, via the bitmap, the target link(s) of which the first device feeds back the MFB information.

For example, the fourth frame includes a second bitmap, the second bitmap includes at least one bit, each bit corresponds to one link, and a value of each bit is configured to indicate whether the first device feeds back MFB information of the corresponding link.

In an example I, the bit taking the value of 1 indicates that the MFB information of the corresponding link is fed back; and the bit taking the value of 0 indicates that the MFB information of the corresponding link is not fed back.

In an example II, the bit taking the value of 0 indicates that the MFB information of the corresponding link is fed back; and the bit taking the value of 1 indicates that the MFB information of the corresponding link is not fed back.

The following is illustrated based on the example I, but the present disclosure is not limited thereto.

In an example, the second bitmap includes k bits corresponding to a link 1 to a link k. When the first bit takes the value of 1, it indicates that MFB information of the link 1 is fed back. When the second bit takes the value of 0, it indicates that MFB information of the link 2 is not fed back. Following bits are similar to the above.

In some embodiments, the fourth frame further includes feedback-type indication information. The feedback-type indication information is configured to indicate a feedback type, such as unsolicited MFB or solicited MFB, that the first device feeds back the MFB information of the target link(s).

In some embodiments, the first device indicates, via the bitmap, the feedback type that the first device feeds back the MFB information of the target link(s).

For example, the fourth frame includes a third bitmap, the third bitmap includes at least one bit, each bit corresponds to one link, and a value of each bit is configured to indicate that the feedback type of the first device feeding back the MFB information of the corresponding link is either unsolicited MFB or solicited MFB.

In an example I, the bit having a value of 1 indicates that the feedback type of the MFB information of the corresponding link is the unsolicited MFB, and the bit having a value of 0 indicates that the feedback type of the MFB information of the corresponding link is the solicited MFB.

In an example II, the bit having the value of 0 indicates that the feedback type of the MFB information of the corresponding link is the unsolicited MFB, and the bit having the value of 1 indicates that the feedback type of the MFB information of the corresponding link is the solicited MFB.

The following is illustrated based on the example I, but the present disclosure is not limited thereto.

In some embodiments, the fourth frame is a BA frame or may be other frames. The following embodiments are illustrated based on the BA frame carrying the MFB information of the at least one link, but the present disclosure is not limited thereto.

In the present embodiment, for distinction and description, when the feedback type of the MFB information of the link is the unsolicited MFB, the MFB information of the link is unsolicited MFB information. When the feedback type of the MFB information of the link is the solicited MFB, the MFB information of the link is solicited MFB information.

In some embodiments, the unsolicited MFB information includes at least one of the following information:

Recommended EHT-MCS, recommended NSS, BW applicable for the recommended EHT-MCS, RU or MRU applicable for the recommended EHT-MCS, partial PPDU parameters (the format and the coding type of the PPDU of which the unsolicited MFB is measured), Tx beamforming indication information (indicates whether the PPDU of which the unsolicited MFB is measured is beamformed), UL EHT TB PPDU MFB information (indicates recommended MFB information for the EHT TB PPDUs that will be sent by the first device, or recommended MFB information for the EHT TB PPDUs that will be sent to the first device).

In other embodiments, the solicited MFB information includes at least one of the following information:

Recommended EHT-MCS, recommended NSS.

In the present embodiment, for distinction and description, the MFB information of the at least one link is categorized, according to the feedback type corresponding to the MFB information of the at least one link, into the following types: multi-link unsolicited MFB information, multi-link solicited MFB information, and multi-link hybrid MFB information. When the feedback type of the MFB information of all the at least one link is the unsolicited MFB, the MFB information of the at least one link is the multi-link unsolicited MFB information. When the feedback type of the MFB information of all the at least one link is the solicited MFB, the MFB information of the at least one link is the multi-link solicited MFB information. When the feedback type of the MFB information of the at least one link includes the unsolicited MFB and the solicited MFB, the MFB information of the at least one link is the multi-link hybrid MFB information.

Therefore, the multi-link adaptation feedback of the first device may include the following cases.

Case 1: Multi-link unsolicited MFB

In the case 1, the first device uses the BA frame to carry the multi-link unsolicited MFB information and sends the BA frame to the second device.

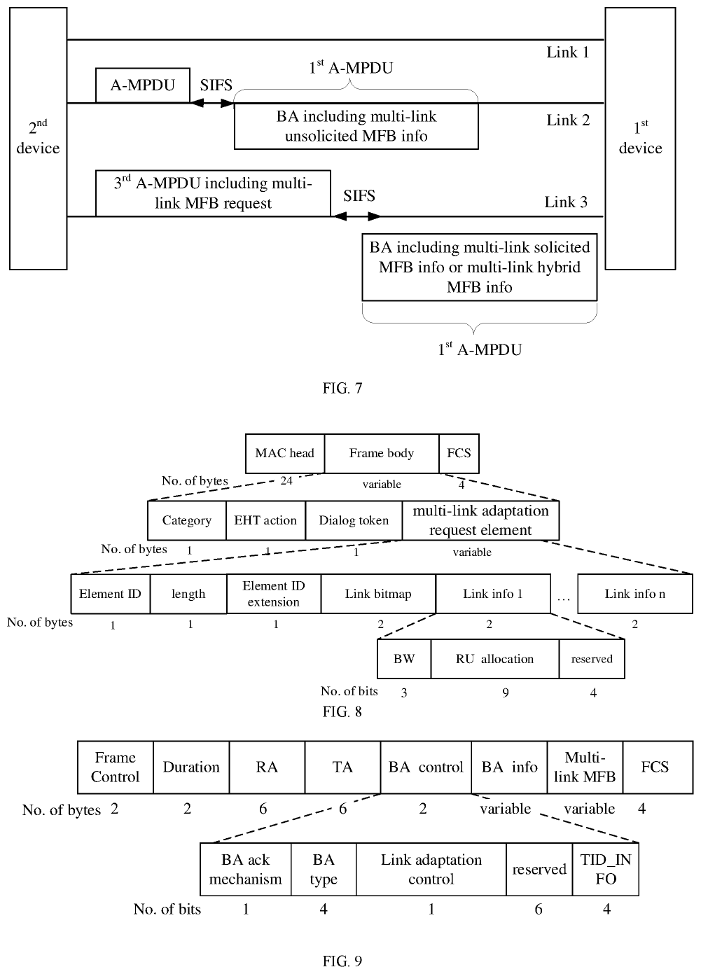

As shown in FIG. 7, three links, a link 1 to a link 3, are established between the first device and the second device. On the link 2, the second device does not send a multi-link MFB request. The first device, in the case of obtaining link adaptation information of the link 2 and the link 3, sends the first A-MPDU to the second device via the link 2. The first A-MPDU includes the BA frame, and the BA frame includes the multi-link unsolicited MFB information. The multi-link unsolicited MFB information includes MFB information of the link 2 and MFB information of the link 3.

Case 2: Multi-link solicited MFB

In a case 2-1, the first device uses the BA frame to carry the multi-link solicited MFB information and sends the BA frame to the second device.

Further, as shown in FIG. 7, in a case, the second device sends a third A-MPDU on the link 3, and the third A-MPDU includes the multi-link MFB request to request the MFB information of the link 2 and the MFB information of the link 3. The first device, after obtaining link adaptation information of the link 2 and the link 3, sends the first A-MPDU via the link 3 to the second device. The first A-MPDU includes the BA frame. The BA frame includes the multilink solicited MFB information. The multi-link solicited MFB information includes the MFB information of the link 2 and the MFB information of the link 3.

In some embodiments, the second device sends the third A-MPDU on the link 3, the third A-MPDU includes the multi-link MFB request to request the MFB information of the link 2 and the MFB information of the link 3. In a case where the first device obtains the link adaptation information of the link 3 but cannot obtain the link adaptation information of the link 2, the first device sends the first A-MPDU via the link 3 to the second device. The first A-MPDU includes the BA frame, and the BA frame includes the multi-link solicited MFB information. The multi-link solicited MFB information includes the MFB information of the link 3. Alternatively, when the first device cannot obtain the link adaptation information of the link 2 and the link 3, the first device sends the first A-MPDU to the second device via the link 3. The first A-MPDU includes the BA frame, and the BA frame includes the multi-link solicited MFB information. The multi-link solicited MFB information does not include the MFB information of any link.

In a case 2-2, the first device uses the BA frame to carry the multi-link hybrid MFB information and sends the BA frame to the second device.

Further, as shown in FIG. 7, the second device sends the third A-MPDU via the link 3, and the third A-MPDU includes the multi-link MFB request to request the MFB information of the link 3. In a case that the first device obtains the link adaptation information of the link 3 and the link adaptation information of the link 2, the first device sends the first A-MPDU via the link 3 to the second device. The first A-MPDU includes the BA frame, and the BA frame includes the multi-link hybrid MFB information. The multi-link hybrid MFB information includes the MFB information of the link 2 and the MFB information of the link 3.

Therefore, it is necessary to design a frame format for carrying the multi-link unsolicited MFB information, the multi-link solicited MFB information, and the multi-link hybrid MFB information.

In the following, as shown in FIG. 8 to FIG. 12, design of formats of the third frame and the fourth frame will be illustrated.

It should be understood that the frame formats in the FIGS. 8 to 12 are only examples, and other frame formats obtained by modifying the exemplified frame formats shall fall within the scope of the present disclosure.

In some embodiments, the third frame may be an action frame or may be achieved as other frames, and the following is illustrated based on the third frame being the action frame, but the present disclosure is not limited thereto.

As an example, a multi-link adaptation request element may be included in the action frame. The multi-link adaptation request element is configured to carry MFB request information

As shown in FIG. 8, the multi-link adaptation request element may include at least one of the following fields:

It should be understood that the correspondence between meanings and the values of each field is only an example, as long as each meaning corresponds to one unique value, and the present disclosure is not limited thereto.

1. The first bitmap (or referred to as link presence bitmap) field is configured to carry the first bitmap described in the above.

Specifically, the link presence bitmap is configured to indicate whether there is a request for feedback on one or more links. For example, when a certain bit is set to 1, it means that a feedback request exists on a link corresponding to the certain bit. When the certain bit is set to 0, it means that there is no feedback request on the link corresponding to the certain bit.

2. A per-link info field is configured to indicate a resource for feeding back the MFB information of the link.

In some embodiments, the number of per-link info fields is determined based on the number of links on which the feedback request exists.

That is, the number of per-link info fields is determined based on the number of target links of which the MFB information is requested to be fed back by the second device. That is, each per-link info field corresponds to one link.

Further, the per-link info field includes at least one of the following fields.

The BW field is configured to indicate a bandwidth that is used to feed back the MFB information of the corresponding link requested by the second device.

The RU allocation field is configured to indicate the RU or MRU that is used to feed back the MFB information of the corresponding target link requested by the second device.

In some embodiments, the second device may request different bandwidths for feeding back the MFB information of different links; or request a same bandwidth for feeding back the MFB information of different links.

As an example, the BW field is set to 0 to indicate 20 MHz, set to 1 to indicate or 40 MHz, set to be 2 to indicate 80 MHz, set to be 3 to indicate 160 MHz, and set to be 4 to indicate 320 MHz.

In some embodiments, the second device may request different RUs or MRUs for feeding back the MFB information of different links; or request a same RU or MRU for feeding back the MFB information of different links.

In some embodiments, the RU allocation field and the BW field cooperatively indicate the specific RU or MRU.

In some embodiments, a dialog token field in the action frame carries the sequence number of the feedback request.

For example, 3 consecutive bits (such as the first 3 bits) of the dialog token field may serve as the MSI to indicate the sequence number of the feedback request.

In some embodiments, the fourth frame may be achieved as the BA frame, or other existing frames, or a new frame. The following is illustrated based on the fourth frame being the BA frame, but the present disclosure is not limited thereto.

FIG. 9 is a schematic view of a frame format of the BA frame that carries the MFB information of at least one link according to an embodiment of the present disclosure. As shown in FIG. 9, the BA frame may include a multi-link MFB field to carry the MFB information of at least one link.

In some embodiments, the multi-link MFB field may be set in a BA information field in the BA frame. For example, a new multi-link MFB field is added into the BA information field. Alternatively, the multi-link MFB field may be in parallel with the BA information field, for example, the multi-link MFB field is set after the BA information field. The present disclosure does not limit a location at which the multi-link MFB field is carried.

In some embodiments, the BA frame further includes a link adaptation control field to indicate whether the BA frame includes the MFB information of one or more links. For example, the link adaptation control field is set to 1 to indicate that the BA frame includes the MFB information of one or more links. The link adaptation control field is set to 0 to indicate that the BA frame does not include the MFB information of any link.

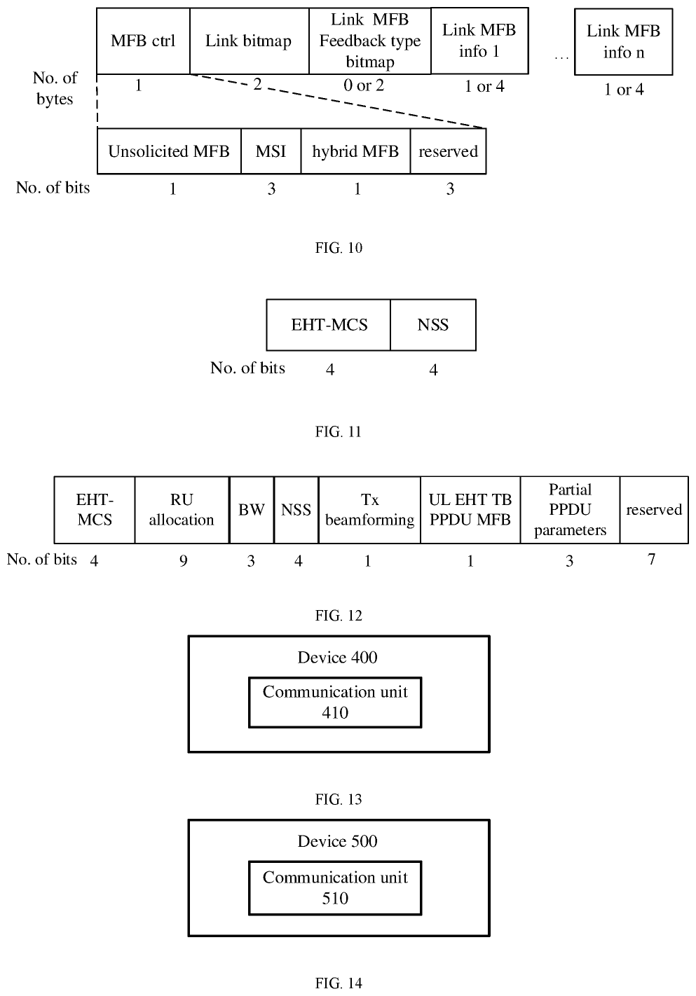

FIG. 10 is a schematic view of a frame format of the multi-link MFB field. As shown in FIG. 10, the multi-link MFB field may include at least one of the following fields:

1. An MFB control field is configured to indicate the MSI of the feedback response and/or the feedback type of the MFB information.

In some embodiments, the MFB control field may include at least one of the following fields.

The MSI field is configured to indicate a sequence number of a feedback response, which is the same as the sequence number of the corresponding feedback request.

An unsolicited MFB field is configured to indicate that the feedback type is a multi-link unsolicited MFB or a multi-link solicited MFB.

A hybrid MFB field is configured to indicate that the feedback type is the multi-link solicited MFB or a multi-link hybrid MFB.

In some embodiments, when the unsolicited MFB field is set to 0, the MSI field indicates the sequence number of the feedback response, which is the same as the sequence number of the feedback request. When the unsolicited MFB field is set to 1, the MSI field isreserved.

In some embodiments, the unsolicited MFB field is set to 1 to indicate the multi-link unsolicited MFB, and in this case, the link MFB information (or referred to as the per-link MFB info) field is referred to as an unsolicited per-link MFB info field.

In some embodiments, the unsolicited MFB field being set to 0 and the hybrid MFB field being set to 0 indicates the multi-link solicited MFB, and in this case, the per-link MFB info field is referred to as a solicited per-link MFB info field.

In some embodiments, the unsolicited MFB field being set to 0 and the hybrid MFB field being set to 1 indicates the multi-link hybrid MFB.

In some embodiments, the unsolicited per-link MFB info field includes 4 bytes, and the solicited per-link MFB info field includes 1 byte.

In some embodiments, for the multi-link hybrid MFB, the feedback type of each link may be indicated by a third bitmap (or referred to as a link MFB type bitmap or a per-link MFB type bitmap) field. Therefore, the number of bytes included in each per-link MFB info field may be determined based on the per-link MFB type bitmap field.

In some embodiments, when the feedback type is the multi-link unsolicited MFB or the multi-link solicited MFB, the per-link MFB type bitmap field is not present.

2. A second bitmap (or referred to as a link presence bitmap) field is configured to indicate whether the first device feeds back the MFB information of the corresponding link(s), or whether the MFB information of the corresponding link(s) is present in the BA frame.

For example, when the bit is set to 1, it is indicated that the MFB information of the corresponding link is present. When the bit is set to 0, it is indicated that the MFB information of the corresponding link is not present.

As an example, when the first bit of the link presence bitmap field is set to 1, it indicates that the MFB information of the link 1 is present; when the second bit of the link presence bitmap field is set to 1, it indicates that the MFB information of the link 2 is present; and so on.

In some embodiments, the number of per-link MFB info fields is determined based on the number of linksof which the MFB information are present.

3. The per-link MFB type bitmap field is configured to indicate the feedback type of MFB information of each link.

For example, the unsolicited MFB field is set to 0, and the hybrid MFB field is set to 1. In this case, a corresponding bit in the per-link MFB type bitmap field being set to 1 indicates that the feedback type of the corresponding link is the unsolicited MFB; the corresponding bit in the per-link MFB type bitmap field being set to 0 indicates that the feedback type of the corresponding link is the solicited MFB. Alternatively, the corresponding bit in the per-link MFB type bitmap field being set to 0 indicates that the feedback type of the corresponding link is the unsolicited MFB; the corresponding bit in the per-link MFB type bitmap field being set to 1 indicates that the feedback type of the corresponding link is the solicited MFB.

When a certain bit in the link presence bitmap field takes the value of 0, the corresponding bit in the per-link MFB type bitmap field is reserved.

4. The per-link MFB info field is configured to indicate the MFB information of the link.

Hereinafter, as shown in FIGS. 11 and 12, a format of the per-link MFB info field corresponding to the solicited MFB and a format of the per-link MFB info field corresponding to the unsolicited MFB are illustrated.

FIG. 11 is a schematic view of the format of the solicited per-link MFB info field. As shown in FIG. 11, the solicited per-link MFB info field may include at least one of the following fields: the EHT-MCS field and the NSS field. In some embodiments, each field is 4 bits.

FIG. 12 is a schematic view of a format of unsolicited per-link MFB info field. As shown in FIG. 12, the unsolicited per-link MFB info field may include at least one of the following fields:

The EHT-MCS field, the NSS field, the BW field, the RU allocation field, the partial PPDU parameters field, the Tx Beamforming field and the UL EHT TB PPDU MFB field.

In some embodiments, the number of bits of the EHT-MCS field is 4 bits; the number of bits of the NSS field is 4 bits; the number of bits of the BW field is 3 bits; the number of bits of the RU allocation field is 9 bits; the number of bits of the partial PPDU parameters field is 3 bits; the number of bits of the Tx Beamforming field is 1 bit; the number of bits of the UL EHT TB PPDU MFB field is 1 bit.

In the following, meaning of each of the above fields is explained.

The EHT-MCS field is configured to indicate the recommended EHT-MCS.

In some embodiments, the EHT-MCS field is in the unsolicited per-link MFB info field, and the UL EHT TB PPDU MFB field is set to 0. Alternatively, the EHT-MCS field is in the solicited per-link MFB info field. The EHT-MCS field indicates the recommended MCS for the PPDUs that will be sent to the first device, for example, the EHT-MCS field is set to be the EHT-MCS index.

In some embodiments, the EHT-MCS field is in the unsolicited per-link MFB info field, and the UL EHT TB PPDU MFB field is set to 1, and in this case, the EHT-MCS field indicates recommended the MCS for the PPDUs what will be sent from the first device. For example, the EHT-MCS field is set to be the EHT-MCS index.

The NSS field is configured to indicate the number of recommended spatial streams.

The maximum number of spatial streams in the 802.11be is 16. Therefore, the NSS field may be designed to be 4 bits.

In some embodiments, the NSS field is in the unsolicited per-link MFB info field, and the UL EHT TB PPDU MFB field is set to 0. Alternatively, the NSS field is in the solicited per-link MFB info field. In this case, the NSS field indicates the number of recommended spatial streams for the PPDUs that will be sent to the first device, for example, the NSS field is set to be N_{SS}-1.

In some embodiments, the NSS field is in the unsolicited per-link MFB info field, and the UL EHT TB PPDU MFB field is set to 1. In this case, the NSS field indicates the number of recommended spatial streams for the PPDUs that will be sent from the first device, for example, the NSS field is set to be N_{SS}-1.

The BW field is configured to indicate the bandwidth to which the recommended EHT-MCS applies.

The maximum bandwidth supported by the 802.11be is 320 MHz, and therefore, the BW field is designed to be 3 bits.

In some embodiments, when the UL EHT TB PPDU MFB field is set to 0, the BW field indicates the bandwidth applicable to the recommended EHT-MCS for the PPDUs that will be sent to the first device.

In some embodiments, when the UL EHT TB PPDU MFB field is set to 1, the BW field indicates the bandwidth applicable to the recommended EHT-MCS for the EHT TB PPDUs that will be sent from the first device.

The RU allocation field is configured to indicate the RU or the MRU associated with the recommended EHT-MCS.

In the 802.11be, one STA may be assigned with one RU or MRU. Therefore, e RU allocation field may be set to be 9 bits. A specific RU or MRU may be indicated by the RU allocation field in combination with the BW field.

In some embodiments, when the UL EHT TB PPDU MFB field is set to 0, the RU allocation field indicates the RU or MRU applicable to the PPDUs, that will use the recommended EHT-MCS, and be sent to the first device.

In some embodiments, when the UL EHT TB PPDU MFB field is set to 1, the RU allocation field indicates the RU or MRU applicable to the PPDUs, that will use the recommended EHT-MCS, and be sent from the first device.

The partial PPDU parameters field is configured indicate estimating the format of the PPDU upon which the unsolicited MFB is measured, and the coding type of PPDU upon which the unsolicited MFB is measured.

The Tx Beamforming field is applicable to only the unsolicited per-link MFB info field.

In some embodiments, when the UL EHT TB PPDU MFB field is set to 0, the Tx Beamforming field indicates estimating whether the PPDU of the unsolicited MFB is beamformed. For example, the Tx Beamforming field being set to 0 indicates that the PPDU is not beamformed; the Tx Beamforming field being set to 1 indicates that the PPDU is beamformed.

In some embodiments, when the UL EHT TB PPDU MFB field is set to 1, the Tx Beamforming field is reserved.

The UL EHT TB PPDU MFB field is applicable to only the unsolicited per-link MFB info field.

In some embodiments, the UL EHT TB PPDU MFB field is set to 1 to indicate that the NSS field, the MCS field, the BW field, and the RU allocation field is the recommended MFB information for the PPDUs that will be sent from the first device.

In some embodiments, the UL EHT TB PPDU MFB field is set to 0 to indicate that the NSS field, the MCS field, the BW field, and the RU allocation field are the recommended MFB information for the PPDUs that will be sent to the first device.

It should be noted that the lengths, positions, structures, values and meanings corresponding to the values of the fields shown in FIGS. 8-FIG. 12 are only exemplary and may be adjusted according to actual needs, and will not be limited by the present disclosure.

In summary, technical solutions of the embodiments of the present disclosure enable link adaptation feedback in the multi-link scenario in the 802.11be. For example, the MFB information of multiple links are carried in the BA frame. In this way, in an asynchronous transmission scenario, when the device receives, before requesting the feedback of the MFB information of a certain link, the MFB information of the certain link on another link, and when quality of the certain link is poor, the device may quickly adjust link parameters based on the MFB information of the certain link without requesting and receiving the feedback, such that fast link adaption is achieved.

Method embodiments of the present disclosure are described in detail in the above by referring to FIGS. 3 to 12, and device embodiments of the present disclosure will be described in detail below by referring to FIGS. 13 to 17. It should be understood that the device embodiments and the method embodiments correspond to each other, and similar descriptions may be referred to the method embodiments.

FIG. 13 is a schematic view of a wireless communication device 400 according to an embodiment of the present disclosure. As shown in FIG. 13, the device 400 includes the following.

A communication unit 410 is configured to send the first aggregate medium access control protocol data unit (A-MPDU) to the second device. The first A-MPDU includes modulation and coding scheme feedback (MFB) information of at least one link.

In some embodiments, the first A-MPDU includes the first frame. The first frame includes the first extremely high throughput (EHT) link adaptation control field (ELA control field). The first ELA control field is configured to indicate the single-link MFB information.

In some embodiments, the first ELA control field includes the unsolicited MFB field and the MRQ/UL EHT TB PPDU MFB field. The unsolicited MFB field is configured to indicate that the feedback type of the MFB information is the unsolicited MFB or the solicited MFB. In a case where the unsolicited MFB field indicates that the feedback type of the MFB information is the unsolicited MFB, the MRQ/UL EHT TB PPDU MFB field is the UL EHT TB PPDU MFB field. In a case where the unsolicited MFB field indicates that the feedback type of the MFB information is the solicited MFB, the MRQ/UL EHT TB PPDU MFB field is the MRQ field.

In some embodiments, the first frame is the data frame or the management frame.

In some embodiments, the communication unit 410 is configured to:

Receive THE second A-MPDU sent by the second device. The second A-MPDU includes the second frame. The second frame includes the second ELA control field. The second ELA control field is configured to instruct the second device to request the device to feed back the single-link MFB information.

In some embodiments, the second ELA control field includes the unsolicited MFB field and the MRQ/UL EHT TB PPDU MFB field. The unsolicited MFB field and the MRQ/UL EHT TB PPDU MFB field cooperatively instruct the second device to request the device to feed back the single-link MFB information.

In some embodiments, the second frame is the data frame or the management frame.

In some embodiments, the communication unit 410 is configured to:

Receives the third A-MPDU sent by the second device. The third A-MPDU includes the third frame, and the third frame is configured to request the device to feed back the MFB information of the target link(s).

In some embodiments, the third frame includes the first bitmap field. The first bitmap field is configured to indicate the target link of which the second device requests to feed back the MFB information.

In some embodiments, the first bitmap includes at least one bit, each bit corresponds to one link, and each bit takes a value to indicate whether to request feeding back the MFB information of the corresponding link.

In some embodiments, the third frame includes the first bitmap field. The first bitmap field is configured to indicate the target link of which the device is requested to feed back the MFB information.

In some embodiments, the third frame is further configured to indicate resource information requested by the second device for feeding back the MFB information.

In some embodiments, the third frame includes at least one link information field. Each of the at least one link information field corresponds to one target link. The link information field is configured to indicate the resource information requested by the second device for feeding back the MFB information of the corresponding target link.

In some embodiments, the link information field includes the bandwidth field and/or the RU allocation field. The bandwidth field is configured to indicate the bandwidth that is requested by the second device for feeding back the MFB information of the corresponding target link. The RU allocation field is configured to indicate the RU or the MRU requested by the second device for feeding back the MFB information of the corresponding target link.

In some embodiments, the third frame is the action frame.

In some embodiments, the first A-MPDU includes the fourth frame, the fourth frame includes the MFB information of the at least one link.

In some embodiments, the fourth frame is further configured to indicate at least one of the following:

The target link of the MFB information fed back by the device;

The feedback type of the device feeding back the MFB information of the target link.

In some embodiments, the fourth frame further includes the second bitmap, the second bitmap is configured to indicate the target link that the device feeds back the MFB information.

In some embodiments, the second bitmap includes at least one bit, each bit corresponds to one link, each bit takes a value to indicate whether the device feeds back the MFB information of the corresponding link.

In some embodiments, the fourth frame includes the second bitmap field. The second bitmap field is configured to indicate the target link of which the device feeds back the MFB information.

In some embodiments, the fourth frame further includes the third bitmap. The third bitmap is configured to indicate a feedback type of the device feeding back the MFB information of the target link.

In some embodiments, the third bitmap includes at least one bit, each bit corresponds to one link, and each bit takes a value to indicate that the feedback type of the device feeding back the MFB information of the corresponding link is the unsolicited MFB or the solicited MFB.

In some embodiments, the fourth frame includes the third bitmap field. The third bitmap field is configured to indicate that the feedback type of the device feeding back the MFB information of the corresponding link is the unsolicited MFB or the solicited MFB.

In some embodiments, the fourth frame includes at least one link MFB information field. Each link MFB information field corresponds to one link, and the link MFB information field is configured to indicate the MFB information of the corresponding link.

In some embodiments, the feedback type of the MFB information of the link corresponding to the link MFB information field is the solicited MFB, and the link MFB information field includes the EHT-MCS field and the NSS field.

In some embodiments, the feedback type of the MFB information of the link corresponding to the link MFB information field is the unsolicited MFB, and the link MFB information field includes at least one of the following fields:

The EHT-MCS field indicates the recommended EHT-MCS.

The NSS field indicates the recommended NSS.

The bandwidth field indicates the bandwidth to which the recommended EHT-MCS applies.

The RU allocation field indicates the RU or MRU applicable to the recommended EHT-MCS.

The partial PPDU parameters field indicates estimating the PPDU format and coding type of the unsolicited MFB.

The Tx beamforming field indicates estimating whether the PPDU of the unsolicited MFB is beamformed.

The UL EHT TB PPDU MFB field is configured to indicate that the NSS field, the EHT-MCS field, the BW field, and the RU allocation field are MFB information recommended for the EHT TB PPDU that will be sent from the device; or MFB information recommended for the EHT TB PPDU that will be sent to the device.

In some embodiments, the fourth frame further includes first indication information. The first indication information is configured to indicate whether the fourth frame includes the MFB information of the link.

In some embodiments, the fourth frame includes the link adaptation control field. The link adaptation control field is configured to indicate whether the fourth frame includes the MFB information of the link.

In some embodiments, the fourth frame is the BA frame.

In some embodiments, the device is a non-access point station device, and the second device is an access point device.

Alternatively, the device the access point device, and the second device is the non-access point station device.

Alternatively, each of the device and the second device is the non-access point station device.

In some embodiments, the communication unit may be a communication interface or a transceiver, or an input/output interface of a communication chip or a system-on-chip. The processing unit may be one or more processors.

It should be understood that the device 400 of the present disclosure may correspond to the first device in the method embodiments of the present disclosure. The above and other operations and/or functions of the various units in the first device 400 achieve the corresponding operations of the first device in the method 200 shown in FIGS. 3 to 12, and thus, are not repeated herein.

FIG. 14 is a schematic view of a wireless communication device according to an embodiment of the present disclosure. The wireless communication device 500 in FIG. 14 includes the following.

A communication unit 510 is configured to receive the first A-MPDU sent by the first device. The first A-MPDU includes the MFB information of at least one link.

In some embodiments, the first A-MPDU includes the first frame, the first frame includes the first ELA control field. The first ELA control field is configured to indicate single-link MFB information.

In some embodiments, the first ELA control field includes the unsolicited MFB field and the MRQ/UL EHT TB PPDU MFB field. The unsolicited MFB field is configured to indicate that the feedback type of the MFB information is the unsolicited MFB or the solicited MFB. In a case where unsolicited MFB field indicates that the feedback type of the MFB information is the unsolicited MFB, the MRQ/UL EHT TB PPDU MFB field is the UL EHT TB PPDU MFB field. In a case where unsolicited MFB field indicates that the feedback type of the MFB information is the solicited MFB, the MRQ/UL EHT TB PPDU MFB field is the MRQ field.

In some embodiments, the first frame is the data frame or the management frame.

In some embodiments, the communication unit 510 is further configured to perform the following.

The communication unit 510 is further configured to send the second A-MPDU to the first device. The second A-MPDU includes the second frame, the second frame includes the second ELA control field. The second ELA control field is configured to instruct the device to request the first device to feed back the single-link MFB information.

In some embodiments, the second ELA control field includes the unsolicited MFB field and the MRQ/ UL EHT TB PPDU MFB field. The unsolicited MFB field and the MRQ/ UL EHT TB PPDU MFB field cooperatively instructs the device to request the first device to feed back the single-link MFB information.

In some embodiments, the second frame is the data frame or the management frame.

In some embodiments, the communication unit 510 is further to perform the following.

The communication unit 510 is further to send the third A-MPDU to the first device, the third A-MPDU includes the third frame, the third frame is configured to request the first device to feed back MFB information of a target link.

In some embodiments, the third frame includes the first bitmap, the first bitmap is configured to indicate a target link of which the device requests to feed back the MFB information.

In some embodiments, the first bitmap comprises at least one bit, each bit corresponds to one link, and the value of each bit is configured to indicate whether the device requests to feed back the MFB information of the corresponding link.

In some embodiments, the third frame includes a first bitmap field, the first bitmap field is configured to indicate the target link on which the MFB information is requested to be fed back from the first device.

In some embodiments, the third frame is further configured to indicate resource information that is requested by the device for feeding back the MFB information.

In some embodiments, the third frame includes at least one link information field, each of the at least one link information field corresponds to one target link. The link information field is configured to indicate the resource information that is requested by the device for feeding back the MFB information of the corresponding target link.

In some embodiments, the link information field includes the bandwidth field and/or the RU allocation field. The bandwidth field is configured to indicate the bandwidth that is requested by the device for feeding back the MFB information of the corresponding target link. The RU allocation field is configured to indicate the RU or the MRU that is requested by the device for feeding back the MFB information of the corresponding target link.

In some embodiments, the third frame is the action frame.

In some embodiments, the first A-MPDU includes the fourth frame, the fourth frame includes the MFB information of the at least one link.

In some embodiments, the fourth frame is further configured to indicate at least one of the following:

The target link of which the first device feeds back the MFB information;

The feedback type of the first device feeding back the MFB information of the target link.

In some embodiments, the fourth frame further includes the second bitmap, the second bitmap is configured to indicate the target link of which the first device feeds back the MFB information.

In some embodiments, the second bitmap includes at least one bit, each bit corresponds to one link, the value of each bit indicates whether the first device feeds back the MFB information of the corresponding link

In some embodiments, the fourth frame further comprises the second bitmap field, the second bitmap field is configured to indicate the target link of which the first device feeds back the MFB information.

In some embodiments, the fourth frame further comprises the third bitmap, the third bitmap is configured to indicate the feedback type of the first device feeding back the MFB information of the target link.

In some embodiments, the third bitmap includes at least one bit, each bit corresponds to one link, and the value of each bit indicates that the feedback type of the first device feeding back the MFB information of the corresponding link is the unsolicited MFB or the solicited MFB.

In some embodiments, the fourth frame comprises the third bitmap field, the third bitmap field is configured to indicate that the feedback type of the first device feeding back the MFB information of the corresponding link is the unsolicited MFB or the solicited MFB.

In some embodiments, the fourth frame comprises at least one link MFB information field. Each link MFB information field corresponds to one link, and the link MFB information field is configured to indicate MFB information of the corresponding link.

In some embodiments, the feedback type of the MFB information of the link corresponding to the link MFB information field is the solicited MFB, and the link MFB information field comprises the EHT-MCS field and the NSS field.

In some embodiments, the feedback type of the MFB information of the link corresponding to the link MFB information field is the unsolicited MFB, and the link MFB information field includes at least one of the following fields:

The EHT-MCS field indicates the recommended EHT-MCS.

The NSS field indicates the recommended NSS.

The bandwidth field indicates the bandwidth to which the recommended EHT-MCS applies.

The RU allocation field indicates the RU or MRU applicable to the recommended EHT-MCS.

The partial PPDU parameters field indicates estimating the PPDU format and coding type of the unsolicited MFB.

The Tx beamforming field indicates estimating whether the PPDU of the unsolicited MFB is beamformed.

The UL EHT TB PPDU MFB field is configured to indicate that the NSS field, the EHT-MCS field, the BW field, and the RU allocation field are MFB information recommended for the EHT TB PPDU that will be sent from the first device; or MFB information recommended for the EHT TB PPDU that will be sent to the first device.

In some embodiments, the fourth frame further includes first indication information. The first indication information is configured to indicate whether the fourth frame includes the MFB information of the link.

In some embodiments, the fourth frame includes the link adaptation control field. The link adaptation control field is configured to indicate whether the fourth frame includes the MFB information of the link.

In some embodiments, the fourth frame is the BA frame.

In some embodiments, the first device is a non-access point station device, and the device is an access point device.

Alternatively, the first device the access point device, and the device is the non-access point station device.

Alternatively, each of the first device and the device is the non-access point station device.

In some embodiments, the communication unit may be a communication interface or a transceiver, or an input/output interface of a communication chip or a system-on-chip. The processing unit may be one or more processors.

It should be understood that the device 500 of the present disclosure may correspond to the second device in the method embodiments of the present disclosure. The above and other operations and/or functions of the various units in the second device 500 achieve the corresponding operations of the second device in the method 200 shown in FIGS. 3 to 12, and thus, are not repeated herein.

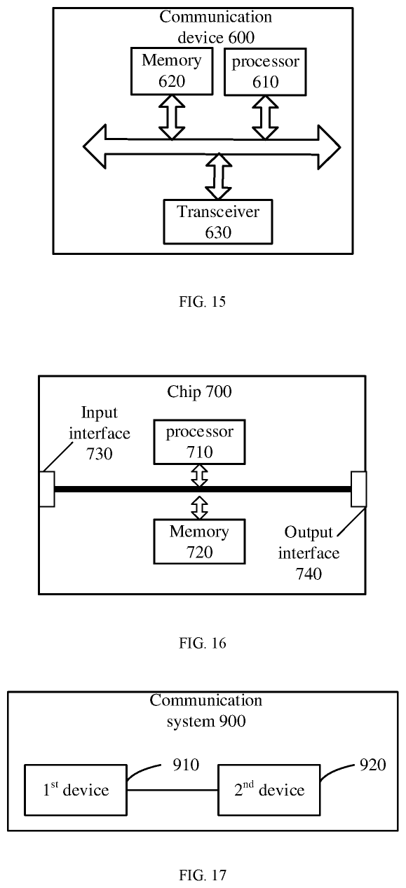

FIG. 15 is a schematic view of a communication device 600 according to an embodiment of the present disclosure. The communication device 600 shown in FIG. 15 includes a processor 610. The processor 610 may invoke and run computer programs from a memory to implement the methods in the embodiments of the present disclosure.

In some embodiments, as shown in FIG. 12, the communication device 600 may further include a memory 620. The processor 610 may invoke and run the computer programs from the memory 620 to implement the methods in the embodiments of the present disclosure.

The memory 620 may be a component independent from the processor 610 or may be integrated into the processor 610.

In some embodiments, as shown in FIG. 15, the communication device 600 may further include a transceiver 630. The processor 610 controls the transceiver 630 to communicate with other components. Specifically, the transceiver 630 is controlled to send information or data to other devices or receive information or data sent from other devices.

The transceiver 630 may include a transmitter and a receiver. The transceiver 630 may further include an antenna, and the number of antennas may be one or more.

In some embodiments, the communication device 600 may specifically be a first device of the present disclosure, and the communication device 600 may implement the corresponding operations implemented by the first device in the various method embodiments of the present disclosure, which will not be repeated herein.

In some embodiments, the communication device 600 may specifically be a second device of the present disclosure, and the communication device 600 may implement the corresponding operations implemented by the second device in the various method embodiments of the present disclosure, which will not be repeated herein.

FIG. 16 is a schematic view of a chip according to an embodiment of the present disclosure. The chip 700 shown in FIG. 16 includes a processor 710. The processor 710 may invoke and run computer programs from a memory to implement the methods of the present disclosure.

In some embodiments, as shown in FIG. 16, the chip 700 may further include a memory 720. The processor 710 may invoke and run the computer programs from the memory 720 to implement the method in the embodiments of the present disclosure.

The memory 720 may be a component independent from the processor 710 or may be integrated into the processor 710.

In some embodiments, the chip 700 may further include an input interface 730. The processor 710 may control the input interface 730 to communicate with other devices or chips, specifically, to obtain information or data sent from other devices or chips.

In some embodiments, the chip 700 may further include an output interface 740. The processor 710 may control the output interface 740 to communicate with other devices or chips, specifically, to output information or data to other devices or chips.

In some embodiments, the chip may be applied to the first device in the embodiments of the present disclosure, and the chip may perform the corresponding operations performed by the first device in the various method embodiments of the present disclosure, which will not be repeated herein.

In some embodiments, the chip may be applied to the second device in the embodiments of the present disclosure, and the chip may perform the corresponding operations performed by the second device in the various method embodiments of the present disclosure, which will not be repeated herein.

It should be understood that the chips in the embodiments of the present disclosure may also be referred to as a system-on-chip, a system chip, a chip system, or a chip-on system chip, and so on.

FIG. 17 is a schematic view of a communication system 900 according to an embodiment of the present disclosure. As shown in FIG. 17, the communication system 900 includes a first device 910 and a second device 920.

The first device 910 may be used to implement corresponding functions implemented by the first device in the method described above. The second device 920 may be used to implement corresponding functions implemented by the first device in the method described above.

It should be understood that the processor of the present disclosure may be an integrated circuit chip having signal processing capabilities. In implementation, the operations of the above method embodiment may be accomplished by integrated logic circuits of hardware in the processor or by instructions in the form of software. The above-described processor may be a general-purpose processor, a digital signal processor (DSP), an application specific integrated circuit (ASIC), an field programmable gate array (FPGA), or other programmable logic devices, a discrete gate or transistor logic device, and a discrete hardware component. Various methods, operations, and logic blocks of the present disclosure may be implemented or performed. The general purpose processor may be a microprocessor or any conventional processor, and so on. The operations of the method disclosed by referring to the embodiments of the present disclosure may be directly achieved by a hardware decoding processor or by a combination of hardware and software modules in a decoding processor. The software module may be located in a random memory, a flash memory, a read-only memory, a programmable read-only memory or an electrically erasable programmable memory, a register, or other storage media that are well established in the art. The storage medium is located in a memory, and the processor reads the information in the memory and completes the operations of the method described above based on the hardware.

It will be understood that the memory in the embodiments of the present disclosure may be a volatile memory or a non-volatile memory or may include both volatile and non-volatile memories. The non-volatile memory may be a read-only memory (ROM), a programmable ROM (PROM), an erasable programmable read-only memory (EPROM), an electrically erasable programmable read-only memory (EEPROM), or a flash memory. The volatile memory may be a random access memory (RAM), which is used as an external cache. By way of illustration, but not limitation, various forms of the RAM are available, such as a static RAM (SRAM), a dynamic RAM (DRAM), a synchronous DRAM (SDRAM), a double data rate SDRAM (SDRAM), an enhanced synchronous SDRAM (ESDRAM), a synchlink DRAM (SLDRAM), and a direct rambus random access memory (DR RAM). It should be noted that the memories of the systems and methods described herein are intended to include, but are not limited to, these and any other suitable types of memories.

It is understood that the above memories are exemplary but not for limitation. For example, the memories of the present disclosure may alternatively be a static random access memory (SRAM), a dynamic random access memory (DRAM), a synchronous DRAM (SDRAM), a double data rate SDRAM (DDR SDRAM), an enhanced SDRAM (ESDRAM), a synch link DRAM (SLDRAM), and a direct rambus random access memory (DR RAM). That is, the memories in embodiments of the present disclosure are intended to include, but are not limited to, these and any other suitable types of memories.

The present disclosure further provides a computer-readable storage medium for storing computer programs.

In some embodiments, the computer-readable storage medium may be applied to the second device in the embodiments of the present disclosure, and the computer programs cause the computer to execute the corresponding operations implemented by the second device in the various method embodiments of the present disclosure, which are not described herein for brevity.

In some embodiments, the computer-readable storage medium may be applied to the first device in the embodiments of the present disclosure, and the computer programs cause the computer to execute the corresponding operations implemented by the first device in the various method embodiments of the present disclosure, which are not described herein for brevity.

The present disclosure further provides a computer program product including computer program instructions.

In some embodiments, the computer program product may be applied to the second device in the embodiments of the present disclosure, and computer program instructions cause the computer to perform the corresponding operations implemented by the second device in the various method embodiments of the present disclosure, which are not repeated herein.

In some embodiments, the computer program product may be applied to the first device in the embodiments of the present disclosure, and computer program instructions cause the computer to perform the corresponding operations implemented by the first device in the various method embodiments of the present disclosure, which are not repeated herein.

The present disclosure further provides a computer program.

In some embodiments, the computer program may be applied to the second device in the embodiments of the present disclosure. When the computer program is run on the computer, the computer is caused to execute the corresponding operations implemented by the second device in the method embodiments of the present disclosure, which will not be repeated herein.

In some embodiments, the computer program may be applied to the first device in the embodiments of the present disclosure. When the computer program is run on the computer, the computer is caused to execute the corresponding operations implemented by the first device in the method embodiments of the present disclosure, which will not be repeated herein.

Any ordinary skilled person in the art may realize that the units and algorithmic operations of the various examples described by referring to the embodiments are capable of being implemented in electronic hardware, or a combination of computer software and electronic hardware. Performing the functions in hardware or software is determined based on particular applications and design constraints of the technical solution. Any ordinary skilled person in the art may use different methods to implement the described functions for each particular application, but the implementations should not be considered out of the scope of the present disclosure.

It is clear to any ordinary skilled person in the art that, for convenience and brevity, specific operation processes of the above-described systems, devices, and units can be referred to the corresponding operations in the foregoing method embodiments, which will not be repeated herein.

In the various embodiments in the present disclosure, it should be understood that the disclosed systems, devices and methods may be implemented in other ways. For example, the device embodiments described above are merely schematic, for example, division of the units is merely a logical functional division, and in practice, the division may be performed in other ways. For example, multiple units or components may be combined or may be integrated into another system, or some components may be omitted or not implemented. Further, coupling or direct coupling or communicative connection between each other may be indirect coupling or communicative connection through some interfaces, devices or units, and may be electrical connection, mechanical connection or connection by other means.

The units that are described as separated components may or may not be physically separated from each other, and the components that are shown as units may or may not be physical units. That is, the components may be located at a place or may be distributed over a plurality of network units. Some or all of these units may be selected to achieve the purpose of the present disclosure.

In some embodiments, the functional units in various embodiments of the present disclosure may be integrated in one processing unit, or the various units may be physically separated from each other, or two or more units may be integrated in one unit.

When the functions are implemented as a software functional unit and sold or used as a separate product, the functions may be stored in a computer-readable storage medium. Therefore, the essence of the technical solution of the present disclosure or a part that contributes to the related art or a part of the entire technical solution may be embodied in the form of a software product. The software product is stored in a storage medium and includes a number of instructions to cause a computer device (which may be a personal computer, a server, or a network device, and so on) to perform all or some of the operations of the methods in the various embodiments of the present disclosure. The aforementioned storage medium includes a USB flash drive, a removable hard disk, a read-only memory (ROM), a random access memory (RAM), a magnetic disc, an optical disc, or other media that can store program codes.

The above description shows only specific embodiments of the present disclosure, but the scope of the present disclosure is not limited thereto. Any variations or substitutions, which can be easily performed within the scope of the technology disclosed in the present disclosure and by any ordinary skilled person in the art, shall be covered by the scope of the present disclosure. Therefore, the scope of the present disclosure shall be subject to the scope of the appended claims.

What is claimed is:

1. A wireless communication method, comprising:
sending, by a first device, a first aggregate medium access control protocol data unit (A-MPDU) to a second device, wherein the first A-MPDU comprises modulation and coding scheme feedback (MFB) information of at least one link;
wherein the first A-MPDU comprises a first frame; the first frame comprises a first extremely high throughput link adaptation control field (ELA control field); the first ELA control field is configured to indicate single-link MFB information;
wherein the first ELA control field comprises an unsolicited MFB field and a modulation and coding scheme (MSC) request (MRQ)/uplink extremely high throughput trigger-based physical layer protocol data unit modulation and coding scheme feedback (UL EHT TB PPDU MFB) field;
wherein the MRQ/UL EHT TB PPDU MFB field is interpreted as an MRQ field or an UL EHT TB PPDU MFB field.

2. The wireless communication method as claimed in claim 1, wherein the unsolicited MFB field is configured to indicate that a feedback type of the MFB information is an unsolicited MFB or a solicited MFB.

3. The wireless communication method as claimed in claim 2, wherein, in a case where the unsolicited MFB field indicates that the feedback type of the MFB information is the unsolicited MFB, the MRQ/UL EHT TB PPDU MFB field is the UL EHT TB PPDU MFB field.

4. The wireless communication method as claimed in claim 2, wherein, in a case where the unsolicited MFB field indicates that the feedback type of the MFB information is the solicited MFB, the MRQ/UL EHT TB PPDU MFB field is the MRQ field.

5. The wireless communication method as claimed in claim 2, wherein, the UL EHT TB PPDU MFB field is set to have a value of 1 to indicate that a number of spatial streams (NSS) field, an MCS field, a bandwidth (BW) field, and a resource unit (RU) allocation field in the first ELA control field is recommended MFB information for PPDUs that will be sent by the first device.

6. The wireless communication method as claimed in claim 2, wherein, the UL EHT TB PPDU MFB field is set to have a value of 0 to indicate that an NSS field, an MCS field, a bandwidth (BW) field, and a resource unit (RU) allocation field in the first ELA control field is recommended MFB information for PPDUs that will be sent to the first device.

7. The wireless communication method as claimed in claim 1, wherein the MFB information of the at least one link comprises at least one of the following:
MCS, the number of spatial streams (NSS), a bandwidth, resource unit (RU) allocation information, partial physical layer protocol data unit (PPDU) parameters, and transmission beam-forming (Tx Beam-forming).

8. The wireless communication method as claimed in claim 7, wherein an BW field in the first ELA control field is designed to be 3 bits to support a maximum bandwidth 320 MHz.

9. The wireless communication method as claimed in claim 1, wherein the unsolicited MFB field is at a first position of a control information field of the first ELA control field.

10. The wireless communication method as claimed in claim 9, wherein the MRQ/UL EHT TB PPDU MFB field is right behind the unsolicited MFB field in the control information field of the first ELA control field.

11. The wireless communication method as claimed in claim 10, wherein the unsolicited MFB and/or the MRQ/UL EHT TB PPDU MFB field is 1 bit.

12. A wireless communication device, comprising: a processor and a memory for storing computer programs, wherein the processor is configured to invoke and run the computer programs stored in the memory to perform operations of:
wherein the first A-MPDU comprises a first frame; the first frame comprises a first extremely high throughput link adaptation control field (ELA control field); the first ELA control field is configured to indicate single-link MFB information;
wherein the first ELA control field comprises an unsolicited MFB field and a modulation and coding scheme (MSC) request (MRQ)/uplink extremely high throughput trigger-based physical layer protocol data unit modulation and coding scheme feedback (UL EHT TB PPDU MFB) field;
wherein the MRQ/UL EHT TB PPDU MFB field is interpreted as an MRQ field or an UL EHT TB PPDU MFB field.

13. The wireless communication device according to claim 12, wherein the unsolicited MFB field is configured to indicate that a feedback type of the MFB information is an unsolicited MFB or a solicited MFB.

14. The wireless communication device according to claim 13, wherein in a case where the unsolicited MFB field indicates that the feedback type of the MFB information is the unsolicited MFB, the MRQ/UL EHT TB PPDU MFB field is the UL EHT TB PPDU MFB field.

15. The wireless communication device according to claim 13, wherein in a case where the unsolicited MFB field indicates that the feedback type of the MFB information is the solicited MFB, the MRQ/UL EHT TB PPDU MFB field is the MRQ field.

16. The wireless communication device according to claim 13, wherein the UL EHT TB PPDU MFB field is set to have a value of 1 to indicate that a number of spatial streams (NSS) field, an MCS field, a bandwidth (BW) field, and a resource unit (RU) allocation field in the first ELA control field is recommended MFB information for PPDUs that will be sent by the first device.

17. The wireless communication device according to claim 13, wherein the UL EHT TB PPDU MFB field is set to have a value of 0 to indicate that an NSS field, an MCS field, a bandwidth (BW) field, and a resource unit (RU) allocation field in the first ELA control field is recommended MFB information for PPDUs that will be sent to the first device.

18. The wireless communication device according to claim 12, wherein the MFB information of the at least one link comprises at least one of the following:
MCS, the number of spatial streams (NSS), a bandwidth, resource unit (RU) allocation information, partial physical layer protocol data unit (PPDU) parameters, and transmission beam-forming (Tx Beam-forming).

19. The wireless communication device according to claim 18, wherein, an BW field in the first ELA control field is designed to be 3 bits to support a maximum bandwidth 320 MHz.

20. A chip, comprising: a processor configured to invoke and run computer programs from a memory to cause a device arranged with the chip to perform the operations of:
sending a first aggregate medium access control protocol data unit (A-MPDU) to a second device, wherein the first A-MPDU comprises modulation and coding scheme feedback (MFB) information of at least one link;
wherein the first A-MPDU comprises a first frame; the first frame comprises a first extremely high throughput link adaptation control field (ELA control field); the first ELA control field is configured to indicate single-link MFB information;
wherein the first ELA control field comprises an unsolicited MFB field and a modulation and coding scheme (MSC) request (MRQ)/uplink extremely high throughput trigger-based physical layer protocol data unit modulation and coding scheme feedback (UL EHT TB PPDU MFB) field;
wherein the MRQ/UL EHT TB PPDU MFB field is interpreted as an MRQ field or an UL EHT TB PPDU MFB field.
